(19) United States
(12) Patent Application Publication
(10) Pub. No.: US 2024/0410522 A1
(43) Pub. Date: Dec. 12, 2024

(54) EZ HEADSET HOLDER

(71) Applicants: Justin Priest, Mount Vernon, WA (US); Brandon Singh, Maple Valley, WA (US); Truong Ma, Everett, WA (US); Kornel Cieslik, Everett, WA (US); Cirrus Cronk, Kernersville, NC (US)

(72) Inventors: Justin Priest, Mount Vernon, WA (US); Brandon Singh, Maple Valley, WA (US); Truong Ma, Everett, WA (US); Kornel Cieslik, Everett, WA (US); Cirrus Cronk, Kernersville, NC (US)

(21) Appl. No.: 18/731,273

(22) Filed: Jun. 1, 2024

Related U.S. Application Data
(60) Provisional application No. 63/471,974, filed on Jun. 8, 2023.

(51) Int. Cl. F16M 13/02; B25J 15/06; F16M 11/14

(52) U.S. Cl. CPC F16M 13/022; B25J 15/0683; F16M 11/14

(57) ABSTRACT

The present invention relates to a device that provides a receptacle for the storage of a headset device. The EZ headset holder may comprise of a spheroidal joint element configuration that allows variability of positioning. The present invention is further comprised of a suction cup that allows for adhesion to varying surfaces. The present invention is additionally comprised of horizontal arm(s) that allow for the support of a headset apparatus.

### FIELD OF INVENTION

The present invention relates to the ornamental and functional design of a device that provides a receptacle for the storage of a headset device.

### BACKGROUND

The use and incorporation of headsets in industrial applications is widespread. Articles of headwear with a transmitter and receiver are required for communication purposes to give and receive instructional information for functions such as navigation. Once the active work relating to the use of a headset has been completed, the headset device requires a storage location in order to not interfere with the activity presently underway.

Current solutions to these existing problems are to store the headset device in an appropriate accommodation or any other medium of similar functionality. While these solutions are simple, they may not provide adequate ease of access in situations of possible high duress (such as flight) where response times are imperative; or in situations of leisure where quality of life may be impacted by repeatedly putting the apparatus in storage and removing it from storage.

Therefore a need exists for a novel solution that reduces both the need for ease of access and storage for a headset apparatus.

### SUMMARY OF THE INVENTION

The present invention relates to the ornamental and functional design of a headset apparatus holder that provides a receptacle that is freely able to rotate in several axis with the ability to be applied in various locations. The apparatus is composed of a suction cup like device for, a spheroidal joint for adjustability, and (1) or (2) arms designed to hang the headset apparatus. These are important features of the present invention as they offer ease of access and adjustability for the user to ornament the device as desired.

### BRIEF DESCRIPTION OF THE DRAWINGS

Some embodiments of the present invention are illustrated as an example and are not limited by the figures of the drawings, in which like references may indicate similar elements and in which:

FIG. 1 depicts a front view of the headset holder according to various embodiments described herein.

FIG. 2 depicts a top view of an example of the headset holder according to various embodiments described herein.

FIG. 3 depicts a side view of an example of the headset holder according to various embodiments described herein.

### DETAILED DESCRIPTION

The terminology used herein is for the direct purpose of ascribing particular embodiments of the present invention and is not intended to be limiting. As used in the descriptive section, the terminology “and/or” includes any and all configurations of one or more of the associated items herein. As further used in the descriptive section, the singular forms of “a,” “an,” and “the” are intended to herein also include the plural forms as well as the singular forms unless clearly outlined or implied contextually. It is to be further understood that the terms “comprises” and/or “comprising” specify the existence of particular features of the present invention and/or its stated applications or embodiments but do not preclude the presence of other features.

Unless otherwise stated, all terminology herein, including technical and scientific terms relating to prior art, are to be understood to have the common definitions that are attributed to one that is ordinarily skilled in the art of which this particular present invention is belonging to, and as such, should be interpreted in that manner.

In the descriptive process of the present invention, it is to be stated that a number of steps and techniques, as to be understood by one of ordinary skill in the art of which the present invention belongs to, are to be disclosed herein the description. For the sake of brevity and clarity the description shall refrain from repeating each possible combination of the present invention. The specification and the claims should be read, and understood, that such combinations are entirely possible in the scope of the present invention.

Novel apparatus' that provide mounting, positioning, and storage are to be discussed herein. Within the following description, for the purpose regarding explanation, specific details are set forth in order to provide a thorough description for the sake of understanding the present invention. It is to be self-evident to one of ordinary skill within the art of which the present invention belongs to that these steps may be practiced without these specific details.

The present disclosure is to be understood as an example of the invention and is not to be limiting of the invention to specific and/or particular embodiments that are illustrated by the figures.

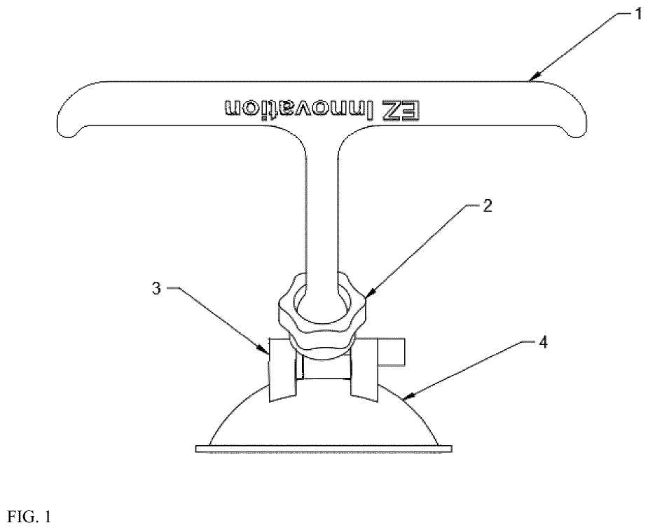

The present invention will now be described referencing the aforementioned figures representing the preferred embodiments. Turning descriptively to the drawings, in which similar reference characters denote similar elements throughout several views. FIG. 1 depicts an example of the Headset Holder according to various embodiments of the present invention. The headset rests 1 may retain a plurality of different headsets or headset like devices and in preferred embodiments is manufactured separately as several components that can be assembled together and may be variably positioned. In other embodiments, the headset holder can be comprised of various materials and thicknesses.

FIG. 1, citing a front view, of the preferred embodiment of the EZ headset holder. The arm portion 1 of the present invention provides a resting mount for a user's headset with a straight edge and curved lip shape to retain user's headset.

FIG. 2, citing a top view, of the preferred embodiment of the EZ headset holder. The suction cup device 5 may be engaged on an appropriate surface vertically or horizontally and clamped further down using lever 4. The arms are allowed to rotate on the spheroidal joint 1 to allow variable positioning for the user's preferred configuration.

FIG. 2, citing a top view, of the preferred embodiment of the EZ headset holder. The nut device 2 may be engaged to loosen or tighten the spheroidal body portion 1 of the headset holder to the configuration of the user(s) preference. The body of the present invention is allowed to rotate on the spheroidal joint 1 and be locked in place by turning the nut device 2 to produce a clamping force to lock the spheroidal joint 1 in a desired configuration.

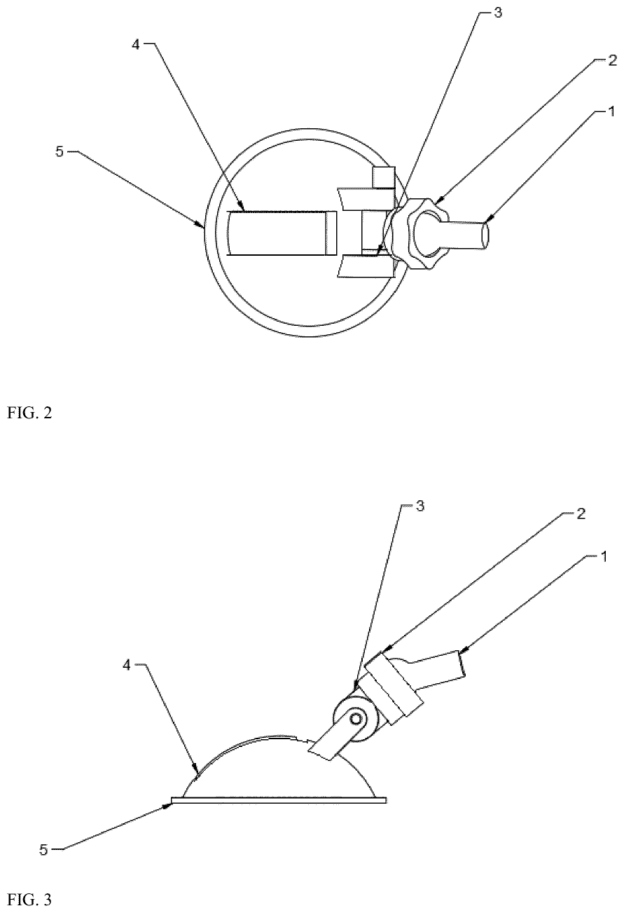

FIG. 3, citing a side view, of the preferred embodiment of the EZ headset holder. The rotational body 3 allows for the user to adjust the angle of the headset arms and lock them in place using both the nut device 2 and the rotational body 3. A bolt holds the rotational body 3 in place at the user desired angle when torqued and allows for adjustability when loosened.

With respect to the above description then, it is to be realized that the optimum dimensional relationship for the parts of the invention; include variations in size, materials, shape, form, function and manner of operation, assembly, and use, are deemed readily apparent and obvious to one competent in the art, and all equivalent relationships to those illustrated in the drawings and described in the specification above are intended to be encompassed in the present invention.

What is claimed is:

1. A functional and ornamental apparatus comprising:
a. A spheroidal joint member;
b. A suction cup
c. Arm(s) to support headset device
d. Ribbed knob to lock/free movement.

2. A functional and ornamental apparatus as in claim 1, wherein the spheroidal joint member allows for variable positioning.

3. A functional and ornamental apparatus as in claim 1, further comprising of a suction cup wherein adhesion to variable locations is allowed.

4. A functional and ornamental apparatus as in claim 1, wherein said arm(s) allow for headset device support.

5. A functional and ornamental apparatus as in claim 1, wherein said ribbed knob is used to tighten and lock down rotational movement for desired position.
